(19) United States
(12) Patent Application Publication
(10) Pub. No.: US 2018/0215905 A1
(43) Pub. Date: Aug. 2, 2018

(54) AIRCRAFT TIRE

(71) Applicant: COMPAGNIE GENERALE DES ETABLISSEMENTS MICHELIN, CLERMONT-FERRAND (FR)

(72) Inventor: JEAN-LUC MANGERET, Clermont-Ferrand (FR)

(21) Appl. No.: 15/748,352

(22) PCT Filed: Jul. 27, 2016
(86) PCT No.: PCT/EP2016/067864

§ 371 Date: Jan. 29, 2018

(30) Foreign Application Priority Data
Jul. 29, 2015 (FR) 15/57239

(51) Int. Cl. C08L 9/06; C08L 7/00; B60C 1/00

(52) U.S. Cl. CPC C08L 9/06; C08L 7/00; B60C 2200/02; C08L 2205/03; C08L 2205/025; B60C 1/0016

(57) ABSTRACT

Tires intended to equip aircraft exhibit an improved wear resistance. The tread of these tires comprises a composition based on at least one reinforcing filler, a crosslinking system and an elastomeric matrix comprising from 15 to 75 phr (per hundred parts of elastomer) of isoprene elastomer, and, from 25 to 85 phr of a tin-functionalized butadiene and styrene copolymer, the total content of isoprene elastomer and of tin-functionalized butadiene and styrene copolymer being within a range extending from 45 to 100 phr.

### TECHNICAL FIELD

The present invention relates to tyres intended to equip aircraft and exhibiting an improved wear resistance, in particular during the landing phase.

### STATE OF THE ART

In a known way, an aircraft tyre has to withstand elevated conditions of pressure, load and speed. Furthermore, it also has to satisfy requirements of wear resistance and of endurance. Endurance is understood to mean the ability of the tyre to withstand, over time, the cyclical stresses to which it is subjected. When the tread of an aircraft tyre is worn, which marks the end of a first serviceable life, the tyre is retreaded, that is to say that the worn tread is replaced by a new tread in order to make possible a second serviceable life. An improved wear resistance makes it possible to carry out a greater number of landings per serviceable life. An improved endurance makes it possible to increase the number of serviceable lives of one and the same tyre.

It is known to use, in aircraft tyre treads, rubber compositions based on natural rubber and on carbon black, these two main elements making it possible to obtain compositions having properties compatible with the conditions of use of an aircraft tyre. In addition to these main elements, these compositions comprise the normal additives for compositions of this type, such as a vulcanization system and protective agents.

Such aircraft tyre tread compositions have been used for many years and exhibit mechanical properties which allow them to withstand the very specific conditions of wear of aircraft tyres. This is because these tyres are subjected to very large variations in temperature and in speed, in particular on landing, where they have to change from a zero speed to a very high speed, bringing about considerable heating and considerable wear. These specific conditions of wear do not concern other types of tyres, such as the tyres of passenger, heavy-duty, civil engineering or aboveground vehicles.

Usually, aircraft tyre tread compositions comprise exclusively natural rubber, the latter making it possible to guarantee an optimum balance between the wear resistance and the thermal stability of the tyre.

In point of fact, it is always advantageous for aircraft tyre manufacturers to find more effective and more resistant solutions, in particular solutions which are more resistant to the extreme and specific conditions of wear generated during the landing of aircraft. One study (S. K. Clark, “Touchdown dynamics”, Precision Measurement Company, Ann Arbor, Mich., NASA, Langley Research Center, Computational Modeling of Tires, pages 9-19, published in August 1995) has described the stresses to which aircraft tyres are subjected on landing and has provided a method for the evaluation of the performance qualities of aircraft tyres during these stresses.

There thus exists a real need to provide aircraft tyres exhibiting a better wear resistance, in particular resistance to the wear generated during landings, while maintaining good mechanical and thermal properties of the tyres.

### ACCOUNT OF THE INVENTION

During their research studies, the Applicant Companies have found that specific compositions of aircraft tyre treads can improve the properties of aircraft tyres, in particular for the landing phase of these tyres, while maintaining good mechanical and thermal properties of the tyres.

Consequently, the invention relates in particular to an aircraft tyre, the tread of which comprises a composition based on at least one reinforcing filler, a crosslinking system and an elastomeric matrix, comprising:
from 15 to 75 parts, per hundred parts of elastomer, phr, of isoprene elastomer, and
from 25 to 85 phr of a tin-functionalized butadiene and styrene copolymer, the total content of isoprene elastomer and of tin-functionalized butadiene and styrene copolymer being within a range extending from 45 to 100 phr.

It also relates to the use of a composition described in the present document in an aircraft tyre tread for improving the wear resistance of the said tyre, in particular the resistance to the wear generated during landings. The use of a tyre according to the invention for improving the wear resistance of the said tyre, in particular the resistance to the wear generated during landings, is also described.

Definitions

The expression “part by weight per hundred parts by weight of elastomer” (or phr) should be understood as meaning, within the meaning of the present invention, the portion by weight per hundred parts of elastomer or rubber.

In the present document, unless expressly indicated otherwise, all the percentages (%) shown are percentages (%) by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b). In the present document, when an interval of values is denoted by the expression “from a to b”, the interval represented by the expression “between a and b” is also and preferably denoted.

In the present document, the expression composition “based on” is understood to mean a composition comprising the mixture and/or the reaction product of the various constituents used, some of these base constituents being capable of reacting or intended to react with one another, at least in part, during the various phases of manufacture of the composition, in particular during the crosslinking or vulcanization thereof.

In the present document, the expression “predominantly comprises” is understood to mean comprises more than 50%. It can, for example, be more than 60%, 70%, 80%, 90%, indeed even 100%. Unless otherwise indicated, the percentages are expressed as percentage by weight.

Unless otherwise indicated, the components described in the present document form part of the composition of the tread of the aircraft tyre according to the present invention. Their respective incorporation contents correspond to their contents in the aircraft tyre tread composition according to the present invention.

Elastomeric Matrix

According to the invention, the elastomeric matrix comprises:
from 15 to 75 phr of isoprene elastomer, and
from 25 to 85 phr of a tin-functionalized butadiene and styrene copolymer, the total content of isoprene elastomer and of tin-functionalized butadiene and styrene copolymer being within a range extending from 45 to 100 phr.

“Isoprene elastomer” is understood to mean, in a known way, an isoprene homopolymer or copolymer, in other words a diene elastomer selected from the group consisting of natural rubber (NR), synthetic polyisoprenes (IRs), various isoprene copolymers and the mixtures of these elastomers. Mention will in particular be made, among isoprene copolymers, of isobutene/isoprene (butyl rubber—IIR), isoprene/styrene (SIR), isoprene/butadiene (BIR) or isoprene/butadiene/styrene (SBIR) copolymers. This isoprene elastomer is preferably natural rubber or a synthetic cis-1,4-polyisoprene, preferably natural rubber. For example, the synthetic polyisoprene can be a polyisoprene having a content (mol %) of cis-1,4-bonds of greater than 90%, more preferably still of greater than 98%.

The elastomers used in the context of the present invention can, for example, be block, random, sequential or microsequential elastomers and can be prepared in dispersion or in solution; they can be coupled and/or star-branched and/or functionalized with a coupling and/or star-branching and/or functionalization agent.

Preferably, according to the invention, the content of isoprene elastomer can be within a range extending from 20 to 70 phr, for example from 20 to 65 or from 30 to 65 phr, for example from 25 to 60 phr, for example from 25 to 50 phr.

The isoprene elastomer can be selected from the group consisting of natural rubber, synthetic polyisoprene and their mixture. Preferably, the isoprene elastomer is natural rubber.

Within the meaning of the present invention, copolymer of butadiene units and of styrene units refers to any copolymer obtained by copolymerization of one or more butadiene(s) with one or more styrene compounds. The following, for example, are suitable as styrene compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene. These elastomers can have any microstructure, which depends on the polymerization conditions used, in particular on the presence or absence of a modifying and/or randomizing agent and on the amounts of modifying and/or randomizing agent employed. The elastomers can, for example, be block, random, sequential or microsequential elastomers and can be prepared in dispersion or in solution.

The tin(Sn)-functionalized butadiene and styrene copolymer, that is to say comprising C—Sn bonds (also known as Sn functionalization), can be functionalized singly (C—Sn bonds at the chain end) and/or coupled (Sn atom between two chains) and/or star-branched (Sn atom between 3 or more chains) with a functionalization and/or coupling and/or star-branching agent. Generically, in order to bring together all these elastomers bonded to tin, the term “tin-functionalized elastomers” is used. These elastomers are known to a person skilled in the art, for example those described in the document WO 2011/042507.

Other types of functionalization exist for styrene and butadiene copolymers, such as silanol or polysiloxane functional groups having a silanol end, or else epoxidized styrene and butadiene copolymers. Such functionalizations are possible in the context of the present invention, in addition to that with tin.

A person skilled in the art well knows the functionalization and/or coupling and/or star-branching agents which can be used in the context of the present invention. Mention may be made, as examples of functionalization agent, of the tin-derived functionalization agents which can correspond to the general formula (X¹₁R¹₂Sn)—O—(SnR¹_{3-y}X¹_{y}) or (X¹₁R¹₂Sn)—O—(CH₂)ₙ—O—(SnR¹_{3-y}X¹_{y}), where y represents an integer having the value 0 or 1, R¹ represents an alkyl, cycloalkyl, aryl, alkaryl or vinyl radical having from 1 to 12 carbon atoms, preferably a butyl, X¹ is a halogen atom, preferably chlorine, and n represents an integer from 1 to 20, preferably 4. Furthermore, mention may be made, as tin-comprising coupling or star-branching agents, of the tin derivatives of formula SnRₓX₄₋ₓ, x representing an integer having a value from 0 to 2, R representing an alkyl, cycloalkyl, aryl, alkaryl, aralkyl or vinyl radical having from 1 to 10 carbon atoms, preferably an alkyl radical having from 1 to 4 carbon atoms, and X is a halogen atom, preferably chlorine. Mention may be made, as preferred tin derivatives, of dibutyltin dichloride or else tin tetrachloride, the latter being very particularly preferred.

The tin-functionalized butadiene and styrene copolymer can be obtained in a way known per se by reaction of a tin derivative with the butadiene and styrene copolymer. The preparation of a star-branched diene elastomer is, for example, described in Patent U.S. Pat. No. 3,393,182.

The tin-functionalized butadiene and styrene copolymer is preferably a random butadiene/styrene copolymer (SBR). Reference will then be made to tin-functionalized SBR (Sn-SBR). It can, for example, concern an SBR prepared in emulsion (“ESBR”) or an SBR prepared in solution (“SSBR”). The contents of vinyl (1,2-), trans-1,4- and cis-1,4-bonds of the butadiene part of the SBR can be variable. For example, the vinyl content can be between 15% and 80% (mol %) and the content of trans-1,4-bonds between 15% and 80% (mol %).

Preferably, according to the invention, the content of tin-functionalized butadiene and styrene copolymer is within a range extending from 30 to 80 phr, for example from 35 to 80 phr, for example from 40 to 75 phr, for example from 50 to 75 phr.

Preferably, the tin-functionalized butadiene and styrene copolymer is a tin-functionalized butadiene and styrene copolymer comprising a low styrene content. The styrene content of the tin-functionalized butadiene and styrene copolymer comprising a low styrene content can be within a range extending from 5% to 25%, preferably from 5% to 20%, more preferably from 10% to 19%.

In a specific embodiment of the present invention, the total content of isoprene elastomer and of tin-functionalized butadiene and styrene copolymer can be 100 phr. In other words, according to this embodiment, the elastomeric matrix of the composition of the tread of the aircraft tyre according to the invention comprises exclusively isoprene elastomer and tin-functionalized butadiene and styrene copolymer.

In another specific embodiment of the present invention, the total content of isoprene elastomer and of tin-functionalized butadiene and styrene copolymer can also be within a range extending from 45 to less than 100 phr. In other words, according to this embodiment, the elastomeric matrix of the composition of the tread of the aircraft tyre according to the invention comprises from more than 0 to 55 phr of another diene elastomer, in addition to the isoprene elastomer and the tin-functionalized butadiene and styrene copolymer. The total content of isoprene elastomer and of tin-functionalized butadiene and styrene copolymer can, for example, be within a range extending from 50 to less than 100 phr, preferably from 45 to 90 phr, preferably from 70 to 80 phr. The term “other diene elastomer” is understood to mean a diene elastomer other than isoprene elastomer and than tin-functionalized butadiene and styrene copolymer.

The term “diene elastomer” should be understood, in a known way, as meaning an (one or more is understood) elastomer resulting at least in part (i.e., a homopolymer or a copolymer) from diene monomers (monomers bearing two conjugated or non-conjugated carbon-carbon double bonds).

These diene elastomers are well known to a person skilled in the art and diene elastomer capable of being used in the compositions is more particularly understood to mean:
any homopolymer obtained by polymerization of a conjugated diene monomer having from 4 to 12 carbon atoms;
any copolymer obtained by copolymerization of one or more conjugated dienes with one another or with one or more vinylaromatic compounds having from 8 to 20 carbon atoms;
a ternary copolymer obtained by copolymerization of ethylene and of an a-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
a copolymer of isobutene and of isoprene (butyl rubber) and also the halogenated versions, in particular chlorinated or brominated versions, of this type of copolymer.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, aryl-1,3-butadiene, 1,3-pentadiene or 2,4-hexadiene. Suitable as vinylaromatic compounds are, for example, styrene, ortho-, meta- or para-methylstyrene, the commercial mixture “vinyltoluene”, para-(tert-butyl)styrene, methoxystyrenes, chlorostyrenes, vinylmesitylene, divinylbenzene or vinylnaphthalene.

Preferably, according to this embodiment of the invention, the other diene elastomer can be selected from the group comprising or consisting of tin-functionalized butadiene and styrene copolymers, polybutadienes and the mixture of at least two, for example 2, 3, 4, 5, indeed even more, of these diene elastomers.

The butadiene and styrene copolymer not functionalized with tin can, for example, be butadiene/styrene copolymer (SBR). It can, for example, concern an SBR prepared in emulsion (“ESBR”) or an SBR prepared in solution (“SSBR”). The contents of vinyl (1,2-), trans-1,4- and cis-1,4-bonds of the butadiene part of the SBR can be variable. For example, the vinyl content can be between 15% and 80% (mol %) and the content of trans-1,4-bonds between 15% and 80% (mol %).

Preferably, according to this embodiment of the invention, the other diene elastomer predominantly comprises a polybutadiene.

Preferably, the polybutadiene can, for example, be a polybutadiene predominantly comprising cis-1,4-bonds. It can, for example, be a composite polybutadiene comprising from 5% to 25% of syndiotactic 1,2-polybutadiene in a cis-1,4-polybutadiene matrix, for example “VCR412 Ubepol” from Ube, comprising 12% of syndiotactic 1,2-polybutadiene in a cis-1,4-polybutadiene matrix.

The content of the other diene elastomer can depend on the nature of this other diene elastomer. This content can be within a range extending from more than 0 to 50 phr, preferably from 10 to 55 phr, preferably from 20 to 30 phr.

When the other diene elastomer predominantly comprises a polybutadiene predominantly comprising cis-1,4-bonds, the content of diene elastomer can be within a range extending from 10 to 30 phr, preferably from 15 to 25 phr.

When the other diene elastomer predominantly comprises composite polybutadiene comprising from 5% to 25% of syndiotactic 1,2-polybutadiene in a cis-1,4-polybutadiene matrix, the content of the other diene elastomer is within a range extending from 10 to 55 phr, preferably from 30 to 55 phr, preferably from 40 to 55 phr, preferably from 45 to 50 phr.

Reinforcing Filler

The reinforcing filler is known for its abilities to reinforce a rubber composition which can be used for the manufacturing of tyres.

According to the invention, the reinforcing filler can predominantly comprise, indeed even exclusively consist of, carbon black. The reinforcing filler can also predominantly comprise, indeed even exclusively consist of, a reinforcing inorganic filler.

Such a reinforcing filler typically consists of nanoparticles, the (weight-)average size of which is less than a micrometre, generally less than 500 nm, most often between 20 and 200 nm, in particular and more preferably between 20 and 150 nm.

The carbon black exhibits a BET specific surface preferably of at least 90 m²/g, more preferably of at least 100 m²/g. The blacks conventionally used in tyres or their treads (“tyre-grade” blacks) are suitable as such. Mention will more particularly be made, among the latter, of the reinforcing carbon blacks of the 100, 200 or 300 series (ASTM grade), such as, for example, the N115, N134, N234 or N375 blacks. The carbon blacks can be used in the isolated state, as available commercially, or in any other form, for example as support for some of the rubber additives used. The BET specific surface of the carbon blacks is measured according to Standard D6556-10 [multipoint (at least 5 points) method—gas: nitrogen—relative pressure p/pₒ range: 0.1 to 0.3].

The term “reinforcing inorganic filler” should be understood here as meaning any inorganic or mineral filler, whatever its colour and its origin (natural or synthetic), also known as “white filler”, “clear filler” or even “non-black filler”, in contrast to carbon black, capable of reinforcing, by itself alone, without means other than an intermediate coupling agent, a rubber composition intended for the manufacture of pneumatic tyres, in other words capable of replacing, in its reinforcing role, a conventional tyre-grade carbon black; such a filler is generally characterized, in a known way, by the presence of hydroxyl (—OH) groups at its surface.

The physical state in which the reinforcing inorganic filler is provided is not important, whether it is in the form of a powder, of micropearls, of granules, of beads or any other appropriate densified form. Of course, the term “reinforcing inorganic filler” is also understood to mean mixtures of different reinforcing inorganic fillers, in particular of highly dispersible siliceous and/or aluminous fillers as described below.

Mineral fillers of the siliceous type, preferably silica (SiO₂), are suitable in particular as reinforcing inorganic fillers. The silica used can be any reinforcing silica known to a person skilled in the art, in particular any precipitated or fumed silica exhibiting a BET specific surface and also a CTAB specific surface both of less than 40-450 m²/g, preferably from 30 to 400 m²/g, in particular between 60 and 300 m²/g.

In the present account, as regards the silica, the BET specific surface is determined in a known way by gas adsorption using the Brunauer-Emmett-Teller method described in The Journal of the American Chemical Society, Vol. 60, page 309, February 1938, more specifically according to French Standard NF ISO 9277 of December 1996 (multipoint (5 point) volumetric method—gas: nitrogen—degassing: 1 hour at 160° C.—relative pressure p/po range: 0.05 to 0.17). The CTAB specific surface is the external surface determined according to French Standard NF T 45-007 of November 1987 (method B).

In order to couple the reinforcing inorganic filler to the diene elastomer, use is made, in a well-known way, of an at least bifunctional coupling agent (or bonding agent) intended to provide a satisfactory connection, of chemical and/or physical nature, between the inorganic filler (surface of its particles) and the diene elastomer. Use is made in particular of at least bifunctional organosilanes or polyorganosiloxanes.

The content of coupling agent is advantageously less than 12 phr, it being understood that it is generally desirable to use as little as possible of it. Typically, the content of coupling agent represents from 0.5% to 15% by weight, with respect to the amount of inorganic filler. Its content is preferably between 0.5 and 9 phr, more preferably within a range extending from 3 to 9 phr. This content is easily adjusted by a person skilled in the art depending on the content of inorganic filler used in the composition.

According to the invention, the content of reinforcing filler can be within a range extending from 20 to 70 phr, preferably from 25 to 55 phr, preferably from 45 to 55 phr.

Crosslinking System

The crosslinking system can be based either, on the one hand, on sulfur or, on the other hand, on sulfur donors and/or on peroxide and/or on bismaleimides. The crosslinking system is preferably a vulcanization system, that is to say a system based on sulfur (or on a sulfur-donating agent) and on a primary vulcanization accelerator. Additional to this base vulcanization system are various known secondary vulcanization accelerators or vulcanization activators, such as zinc oxide, stearic acid or equivalent compounds, or guanidine derivatives (in particular diphenylguanidine), or else known vulcanization retarders, which are incorporated during the first non-productive phase and/or during the productive phase, as described subsequently.

The sulfur can be used at a preferred content of between 0.5 and 12 phr, in particular between 1 and 10 phr. The primary vulcanization accelerator is used at a preferred content of between 0.5 and 10 phr, more preferably of between 0.5 and 5.0 phr.

Various Additives

The rubber composition can also comprise all or a portion of the usual additives customarily used in elastomer compositions intended to constitute treads, such as, for example, plasticizers, pigments, protective agents, such as antiozone waxes, chemical antiozonants or antioxidants, or antifatigue agents.

Aircraft Tyres

The present invention relates to tyres intended to equip aircraft. Aircraft tyres are subjected to highly specific stresses related to their use and exhibit certain distinctive features with respect to other types of tyres, such as tyres of passenger, heavy-duty, civil engineering or aboveground vehicles.

Generally, a tyre comprises a tread intended to come into contact with the ground via a running surface and connected via two sidewalls to two beads, the two beads being intended to provide a mechanical connection between the tyre and the rim on which the tyre is fitted.

A radial tyre more particularly comprises a reinforcement comprising a crown reinforcement radially internal to the tread and a carcass reinforcement radially internal to the crown reinforcement.

The carcass reinforcement of an aircraft tyre generally comprises a plurality of carcass layers extending between the two beads and divided between a first and a second family.

The first family consists of carcass layers which are wound, in each bead, from the inside towards the outside of the tyre, around a circumferential reinforcing element, known as bead thread, in order to form a turn-up, the end of which is generally radially external to the radially outermost point of the bead thread. The turn-up is the carcass layer portion between the radially innermost point of the carcass layer and its end. The carcass layers of the first family are the closest carcass layers to the internal cavity of the tyre and thus the axially innermost, in the sidewalls.

The second family consists of carcass layers which extend, in each bead, from the outside towards the inside of the tyre, as far as an end which is generally radially internal to the radially outermost point of the bead thread. The carcass layers of the second family are the closest carcass layers to the external surface of the tyre and thus the axially outermost, in the sidewalls.

Usually, the carcass layers of the second family are positioned, over their entire length, outside the carcass layers of the first family, that is to say that they cover, in particular, the turn-ups of the carcass layers of the first family. Each carcass layer of the first and of the second family consists of reinforcing elements which are parallel to one another, forming, with the circumferential direction, an angle of between 80° and 100°.

According to the invention, the tyre can comprise a number of carcass layers ranging from 2 to 12, preferably from 5 to 10.

The reinforcing elements of the carcass layers are generally cords consisting of spun textile filaments, preferably made of aliphatic polyamide or of aromatic polyamide, and characterized by their mechanical properties in extension. The textile reinforcing elements are subjected to tension over an initial length of 400 mm at a nominal rate of 200 mm/min. All the results are a mean of 10 measurements.

In use, an aircraft tyre is subjected to a combination of load and of pressure inducing a high degree of bending, typically of greater than 30% (for example than 32% or 35%). The degree of bending of a tyre is, by definition, its radial deformation, or its variation in radial height, when the tyre changes from an unladen inflated state to an inflated state laden statically, under pressure and load conditions as defined, for example, by the standard of the Tyre and Rim Association or TRA. It is defined by the ratio of the variation in the radial height of the tyre to half the difference between the external diameter of the tyre, measured under static conditions in an unladen state inflated to the reference pressure, and the maximum diameter of the rim, measured on the rim flange. The TRA standard defines in particular the squashing of an aircraft tyre by its squashed radius, that is to say by the distance between the axis of the wheel of the tyre and the plane of the ground with which the tyre is in contact under the reference pressure and load conditions.

An aircraft tyre is furthermore subjected to a high inflation pressure, typically of greater than 9 bar. This high pressure level implies a large number of carcass layers, as the carcass reinforcement is proportioned in order to ensure the resistance of the tyre to this pressure level with a high safety factor. By way of example, the carcass reinforcement of a tyre, the operating pressure of which, as recommended by the TRA standard, is equal to 15 bar, has to be proportioned to resist a pressure equal to 60 bar, assuming a safety factor equal to 4. Thus, according to the invention, the tyre can have an inflation pressure of greater than 9 bar, preferably of 9 to 20 bar.

The aircraft tyres according to the present invention can be used on any type of aircraft. They are particularly advantageous for aircraft using large-sized tyres. This is because the greater the size of an aircraft tyre, the greater will be the impact of the wear on landing on the overall wear of the tyre. Thus, according to the invention, the tyre can have a size of greater than 18 inches, preferably of 20 to 23 inches.

In use, the running mechanical stresses induce bending cycles in the beads of the tyre, which are wound around the rim flanges. These bending cycles generate in particular, in the portions of the carcass layers located in the region of bending on the rim, variations in curvature combined with variations in elongation of the reinforcing elements of the carcass layers. These variations in elongation or deformations, in particular in the axially outermost carcass layers, can have negative minimum values, corresponding to being placed in compression. This placing in compression is capable of inducing fatigue failure of the reinforcing elements and thus a premature degradation of the tyre.

Thus, the aircraft tyre according to the invention is preferably an aircraft tyre which is subjected, during its use, to a combination of load and of pressure inducing a degree of bending of greater than 30.

Likewise, the aircraft tyre according to the invention is preferably an aircraft tyre comprising, in addition to the tread, an internal structure comprising a plurality of carcass layers extending between the two beads and divided between a first and a second family, the first family consisting of carcass layers which are wound, in each bead, from the inside towards the outside of the tyre and the second family consisting of carcass layers extending, in each bead, from the outside towards the inside of the tyre.

Preparation of the Rubber Compositions

The compositions used in the aircraft tyre treads of the invention can be manufactured in appropriate mixers, using two successive preparation phases according to a general procedure well known to those skilled in the art: a first phase of thermomechanical working or kneading (sometimes referred to as “non-productive” phase) at high temperature, up to a maximum temperature of between 130° C. and 200° C., preferably between 145° C. and 185° C., followed by a second phase of mechanical working (sometimes referred to as “productive” phase) at lower temperature, typically below 120° C., for example between 60° C. and 100° C., during which finishing phase the chemical crosslinking agent, in particular the vulcanization system, is incorporated.

The composition of the tread of the tyre in accordance with the invention can be either in the raw state (before crosslinking or vulcanization) or in the cured state (after crosslinking or vulcanization) and can be a semi-finished product which can be used in a tyre, in particular in a tyre tread.

The abovementioned characteristics of the present invention, and also others, will be better understood on reading the following description of several implementational examples of the invention, given by way of illustration and without limitation.

### EXAMPLES

I. Measurements and Tests Used

I.1 Tensile Tests

These tensile tests make it possible to determine the moduli of elasticity and the properties at break and are based on Standard NF ISO 37 of December 2005 on a type-2 dumbbell test specimen. The elongation at break thus measured at 60° C. is expressed as % of elongation.

I.2 Loss in Weight

This test makes it possible to determine the loss in weight of a sample of aircraft tyre tread composition when it is subjected to an abrasion test on a high-speed abrasion tester.

The high-speed abrasion test is carried out according to the principle described in the paper by S. K. Clark, “Touchdown dynamics”, Precision Measurement Company, Ann Arbor, Mich., NASA, 35 Langley Research Center, Computational Modeling of Tires, pages 9-19, published in August 1995. The tread material rubs over a surface, such as a Norton Vulcan A30S-BF42 disc. The linear speed during contact is 70 m/s with a mean contact pressure of 15 to 20 bar. An energy of 10 to 20 MJ/m² of contact surface is brought into play during the experiment.

The components of the constant-energy tribometry device according to the abovementioned paper by S. K. Clark are a motor, a clutch, a rotating plate and a sample holder.

Components of the constant-energy tribometry device according to the abovementioned paper by S. K. Clark:
small wheel (toroidal ring made of test material mounted on a grooved pulley)
rotating plate, for example consisting of a Norton disc integral with the axis of an electric motor and of a flywheel.

The performance is evaluated on the basis of the loss in weight according to the following formula:

[Loss in weight performance=loss in weight control/loss in weight sample]

The results are expressed in base 100. A performance for the sample of greater than 100 is regarded as better than the control.

I.3 Dynamic Properties (After Curing)

The dynamic properties G* and tan(δ)max are measured on a viscosity analyser (Metravib V A4000) according to Standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, at 60° C., according to Standard ASTM D 1349-99, is recorded. A peak-to-peak strain amplitude sweep is carried out from 0.1% to 50% (outward cycle) and then from 50% to 1% (return cycle). The results made use of are the complex dynamic shear modulus (G*) and the loss factor tan(δ). The maximum value of tan(δ) observed (tan(δ)max) and the difference in complex modulus (G*) between the values at 0.1% and at 50% strain (Payne effect) are shown for the return cycle. The lower the value for the values of tan(δ)max at 60° C., the lower will be the hysteresis of the composition and thus the lower will be the heating.

II. Preparation of the Compositions and Their Properties in the Cured State

The compositions I1 to I5, C1, C2 and C3, the formulations of which in phr appear in Tables 1 and 2, were prepared in the following way.

The diene elastomers, the reinforcing fillers and also the various other ingredients, with the exception of the vulcanization system, are successively introduced into an internal mixer (final degree of filling: approximately 70% by volume), the initial vessel temperature of which is approximately 80° C. Thermomechanical working (non-productive phase) is then carried out in one stage, which lasts in total approximately 3 to 4 min, until a maximum “dropping” temperature of 165° C. is reached. The mixture thus obtained is recovered and cooled and then sulfur and an accelerator of sulfamide type are incorporated on a mixer (homofinisher) at 70° C., everything being mixed (productive phase) for an appropriate time (for example approximately ten minutes).

The compositions thus obtained are subsequently calendered, either in the form of plaques (thickness of 2 to 3 mm) or of thin sheets of rubber, for the measurement of their physical or mechanical properties, or extruded in the form of an aircraft tyre tread.

### Example 1

The aim of this example is to show the influence of the content of incorporation of tin-functionalized SBR in aircraft tyre tread compositions on the performance compromise between the wear resistance and the preservation of the mechanical and thermal properties.

C1, C2 and C3 are control compositions. C1 corresponds to the composition of an aircraft tread conventionally used by a person skilled in the art; it is based on natural rubber as sole elastomer. C2 corresponds to a tread composition in which the natural rubber has been replaced by a tin-functionalized SBR. C3 corresponds to a tread composition in which half of the natural rubber has been replaced by a polybutadiene.

The tests I1 to I3 are in accordance with the invention. The compositions I1 to I3 differ in the respective contents of natural rubber and of tin-functionalized SBR.

The performance results for loss in weight and for elongation at break at 60° C. are expressed as percentage, base 100, with respect to the control composition C1 corresponding to the ordinary tread compositions.

TABLE 1

| | C1 | I1 | I2 | I3 | C2 | C3 |
|---|---|---|---|---|---|---|
| NR (1) | 100 | 70 | 50 | 25 | — | 50 |
| SBR (2) | — | 30 | 50 | 75 | 100 | — |
| BR (3) | — | — | — | — | — | 50 |
| Carbon black (4) | 49 | 49 | 49 | 49 | 49 | 49 |
| Antioxidant (5) | 1.5 | 1.5 | 1.5 | 1.5 | 1.5 | 1.5 |
| Ozone wax | 1 | 1 | 1 | 1 | 1 | 1 |
| Stearic acid | 2.5 | 2.5 | 2.5 | 2.5 | 2.5 | 2.5 |
| Zinc oxide (6) | 3 | 3 | 3 | 3 | 3 | 3 |
| Accelerator (7) | 0.85 | 0.85 | 0.85 | 0.85 | 0.85 | 0.85 |
| Sulfur | 1.6 | 1.6 | 1.6 | 1.6 | 1.6 | 1.6 |
| Performance Loss in weight as % | 100 | 105 | 114 | 126 | 157 | 102 |
| base 100 with respect to C1 | | | | | | |
| Elongation at break at 60° C. as % | 100 | 91 | 82 | 80 | 59 | 85 |
| base 100 with respect to C1 | | | | | | |
| Tan(δ)max at 60° C. | 0.19 | 0.18 | 0.18 | 0.17 | 0.17 | 0.17 |

(1) Natural rubber
(2) Tin-functionalized solution SBR, with 24% of 1,2-polybutadiene units, 15.5% of styrene units - Tg = −65° C.
(3) Neodymium polybutadiene, 98% 1,4-cis- - Tg = −108° C.
(4) Carbon black of N234 grade according to Standard ASTM D-1765
(5) N-(1,3-Dimethylbutyl)-N-phenyl-para-phenylenediamine, Santoflex 6-PPD from Flexsys
(6) Zinc oxide of industrial grade from Umicore
(7) N-Cyclohexyl-2-benzothiazolesulfenamide, Santocure CBS from Flexsys

The results presented in Table 1 above show that the loss in weight performance, representative of a better wear resistance during the landing phase, of the compositions I1 to I3 is always significantly improved with respect to the control.

Furthermore, these compositions I1 to I3 exhibit an elongation at break at 60° C. which is lower by 20%, with respect to the control C1 (composition of an aircraft tread conventionally used by a person skilled in the art to manufacture an aircraft tyre tread), which remains an acceptable level for the mechanical properties. Beyond a fall of 20% with respect to C1, it may be considered that the mechanical properties might no longer be regarded as sufficient for the tread composition to be used on aircraft tyres.

The above results also show that the thermal stability of the composition, represented by the tan(δ)max values at 60° C., is maintained, indeed even improved, with respect to the control C1.

As shown by the results for the composition C2, the absence of natural rubber in the composition brings about a strong fall in the mechanical properties. In addition, the composition C3, corresponding to a tread composition in which half of the natural rubber has been replaced by a polybutadiene, does not make it possible to significantly improve the wear resistance.

Thus, only the compositions in accordance with the invention have the advantage of making possible a better wear resistance during the landing phase of the aircraft, while maintaining, indeed even improving, the thermal properties of the composition and while keeping the mechanical properties at an acceptable level. It is observed that the use of 45 to 75 phr of tin-functionalized SBR in the composition results in a better performance compromise between the wear resistance and the maintenance of the thermal and mechanical properties.

### Example 2

The aim of this example is to show the influence of the incorporation of other diene elastomers in addition to the tin-functionalized SBR on the performance compromise between the wear resistance and the preservation of the mechanical and thermal properties.

I2 corresponds to the composition I2 of Example 1. It corresponds to an embodiment of the invention in which only the tin-functionalized SBR is present in addition to the diene elastomer.

The tests 14 and 15 are also in accordance with the invention. The compositions 14 and 15 comprise additional synthetic elastomers different in nature, as shown in Table 2 below.

The performance results for loss in weight and for elongation at break at 60° C. are expressed as percentage, base 100, with respect to the control composition C1 of Example 1.

TABLE 2

| | I2 | I4 | I5 |
|---|---|---|---|
| NR (1) | 50 | 35 | 30 |
| SBR (2) | 50 | 45 | — |
| SBR (3) | — | — | 20 |
| BR (4) | — | 20 | — |
| VCR412 (5) | — | — | 50 |
| Carbon black (6) | 49 | 49 | 49 |
| Antioxidant (7) | 1.5 | 1.5 | 1.5 |
| Ozone wax | 1 | 1 | 1 |
| Stearic acid | 2.5 | 2.5 | 2.5 |
| Zinc oxide (8) | 3 | 3 | 3 |
| Accelerator (9) | 0.85 | 0.85 | 0.85 |
| Sulfur | 1.6 | 1.6 | 1.6 |
| Performance Loss in weight as | 114 | 118 | 138 |
| % base 100 with respect to C1 | | | |
| Elongation at break at 60° C. as | 82 | 108 | 95 |
| % base 100 with respect to C1 | | | |
| Tan(δ) at 60° C. | 0.18 | 0.18 | 0.20 |

(1) Natural rubber
(2) Tin-functionalized solution SBR, with 24% of 1,2-polybutadiene units, 15.5% of styrene units - Tg = −65° C.
(3) Tin-functionalized solution SBR, with 24% of 1,2-polybutadiene units, 26.5% of styrene units - Tg = −48° C.
(4) Neodymium polybutadiene, 98% 1,4-cis- - Tg = −108° C.
(5) VCR412 Ubepol from Ube - composite polybutadiene: 12% of syndiotactic 1,2-polybutadiene in a cis-1,4-polybutadiene matrix
(6) Carbon black of N234 grade according to Standard ASTM D-1765
(7) N-(1,3-Dimethylbutyl)-N-phenyl-para-phenylenediamine, Santoflex 6-PPD from Flexsys
(8) Zinc oxide of industrial grade from Umicore
(9) N-Cyclohexyl-2-benzothiazolesulfenamide, Santocure CBS from Flexsys

The results presented in Table 2 above show that the loss in weight performance, representative of a better wear resistance during the landing phase, of the compositions I4 and I5 is always significantly improved with respect to the control C1 and are comparable with, indeed even superior to, the composition 12 in accordance with the present invention.

Furthermore, these compositions exhibit an elongation at break at 60° C. which is much less than 20%, indeed even greater, with respect to the control C1, and the thermal stability of the composition is also maintained, with respect to the control C1. These results are comparable with, indeed even superior to, the composition I2 in accordance with the present invention.

Thus, the compositions in accordance with the invention, whether they do or do not comprise another diene elastomer in addition to the isoprene elastomer and the tin-functionalized SBR, have the advantage of providing a better wear resistance during the landing phase of the aircraft, while maintaining, indeed even improving, the thermal properties of the composition and while retaining good mechanical properties.

1.-21. (canceled)

22. An aircraft tire, the tread of which comprises a composition based on at least one reinforcing filler, a crosslinking system and an elastomeric matrix, the elastomeric matrix comprising:
15 to 75 phr of isoprene elastomer;
25 to 85 phr of a tin-functionalized butadiene and styrene copolymer; and
greater than 0 to 55 phr of another diene elastomer,
wherein phr is per hundred parts of elastomer,
wherein a total content of isoprene elastomer and of tin-functionalized butadiene and styrene copolymer is within a range extending from 45 to 100 phr,
wherein the another diene elastomer is selected from the group consisting of butadiene and styrene copolymers which are not functionalized with tin, polybutadienes and mixtures thereof.

23. The aircraft tire according to claim 22, wherein the content of isoprene elastomer is within a range extending from 20 to 65 phr.

24. The aircraft tire according to claim 22, wherein the isoprene elastomer is selected from the group consisting of natural rubber, synthetic polyisoprene and mixtures thereof.

25. The aircraft tire according to claim 22, wherein the isoprene elastomer is natural rubber.

26. The aircraft tire according to claim 22, wherein the content of tin-functionalized butadiene and styrene copolymer is within a range extending from 35 to 80 phr.

27. The aircraft tire according to claim 22, wherein the tin-functionalized butadiene and styrene copolymer is a tin-functionalized butadiene and styrene copolymer comprising a low styrene content, the styrene content being within a range extending from 5% to 25%.

28. The aircraft tire according to claim 27, wherein the tin-functionalized butadiene and styrene copolymer is a tin-functionalized butadiene and styrene copolymer comprising a low styrene content, the styrene content being within a range extending from 10% to 19%

29. The aircraft tire according to claim 22, wherein the tin-functionalized butadiene and styrene copolymer is a random tin-functionalized butadiene/styrene copolymer.

30. The aircraft tire according to claim 22, wherein the elastomeric matrix comprises from more than 0 to 50 phr of the another diene elastomer.

31. The aircraft tire according to claim 22, wherein the another diene elastomer predominantly comprises a polybutadiene.

32. The aircraft tire according to claim 22, wherein the another diene elastomer predominantly comprises a polybutadiene predominantly comprising cis-1,4-bonds.

33. The aircraft tire according to claim 31, wherein the content of the another diene elastomer is within a range extending from 10 to 30 phr.

34. The aircraft tire according to claim 22, wherein the another diene elastomer predominantly comprises a composite polybutadiene, which comprises from 5% to 25% of syndiotactic 1,2-polybutadiene in a cis-1,4-polybutadiene matrix.

35. The aircraft tire according to claim 34, wherein the content of the another diene elastomer is within a range extending from 10 to 55 phr.

36. The aircraft tire according to claim 22, wherein the reinforcing filler comprises carbon black, a reinforcing inorganic filler, or a mixture thereof.

37. The aircraft tire according to claim 36, wherein the reinforcing inorganic filler is a silica.

38. The aircraft tire according to claim 36, wherein the reinforcing filler predominantly comprises carbon black.

39. The aircraft tire according to claim 22, further comprising a number of carcass layers ranging from 2 to 12.

40. The aircraft tire according to claim 22, wherein a size of the aircraft tire is greater than or equal to 18 inches.
